(19) United States
(12) Patent Application Publication
(10) Pub. No.: US 2007/0164075 A1
(43) Pub. Date: Jul. 19, 2007

(54) ANTI-MISFIT STRUCTURE FOR A NAIL CARTRIDGE

(75) Inventors: Jack Chen, Taichung City (TW); Tsung-Min Hsu, Taichung City (TW)

Correspondence Address: EGBERT LAW OFFICES, 412 MAIN STREET, 7TH FLOOR, HOUSTON, TX, 77002, US

(73) Assignee: BASSO INDUSTRY CORP., Taichung City (TW)

(21) Appl. No.: 11/622,917

(22) Filed: Jan. 12, 2007

(30) Foreign Application Priority Data
Jan. 17, 2006 (TW) 095101750

(51) Int. Cl. B25C 5/06

(52) U.S. Cl. 227/119; 227/120

(57) ABSTRACT

The present invention provides an anti-misfit structure for a nail cartridge, which resolves the problems of a typical nail cartridge. For example, when a short collated nail is mistakenly inserted, it is likely lead to different triggering strength, and easier swinging and jamming of nail bodies against stability and safety. The swinging end of the spring of the nail cartridge is provided with a stopper. So, when the nailer head of a short collated nail is mistakenly inserted into the long nailer head dent, the stopper blocks the collated nail, thus preventing any misalignment and subsequent triggering of a nailer for higher stability and safety.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a structure of a nail cartridge, and more particularly to an innovative anti-misfit structure for a nail cartridge.

2. Description of Related Art

Including Information Disclosed Under 37 CFR 1.97 and 37 CFR 1.98.

The nail cartridge is used to accommodate and guide collated nails.

The collated nails are rows of nail bodies linked by a connecting band. Given the currently available types of nailers, the present invention relates more particularly to a nailer with a T-shaped profile, namely, wherein the nails of the nailer have an expanded nail head.

FIG. 1 depicts the typical nail cartridge 10, wherein a nail tank 11 is generally provided with a spring 12 to insert the collated nails for flexible positioning. According to the specified pattern of the nail body, the inlet 13 of the nail tank 11 is formed into a T-shaped inlet to match the collated nails for stable motion. The marketable nail bodies of collated nails are divided into two types. As such, upper and lower T-shaped inlets 131, 132 are located at inlet 13 of nail tank 11 in the nail cartridge 10. If longer collated nails 20a are inserted, as shown in FIG. 1, the nail head 22a of nail body 21a aligns with the upper T-shaped inlet 131 for insertion. Otherwise, if shorter collated nails 20b are inserted, as shown in FIG. 2, the nail head 22b of nail body 21b aligns with lower T-shaped inlet 132 for insertion (as shown for the location of collated nails represented by the broken line in FIG. 2).

This nail cartridge has disadvantages during application. If longer collated nails are inserted and if the maximum size of the inlet of the nail tank matches the longer collated nail, then it is impossible to load nails smoothly because any misalignment or directional errors would affect loading, as shown in FIG. 1. If shorter collated nails 20b are inserted and if inlet 13 of the nail tank 11 has upper and lower T-shaped inlets 131, 132, then it is possible to load the shorter collated nails 20b smoothly into upper T-shaped inlet 131, even with misalignment, as shown in FIG. 2. However, if shorter collated nails are triggered in such a state, the nail ejection strength is far below the expectation due to a longer distance between the bottom of nail body 21b and ejection hole of the nailer. Furthermore, the shorter collated nails triggered in such a state provide a bigger probability of deflection and jamming with increasing instability and risk to nailer applications.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention includes a swinging end 62 of the spring 60 of nail cartridge 30 being provided with a stopper 70. When the nail head 51b of a short collated nail 50b is mistakenly inserted into the long nail head dent 321, the stopper 70 blocks the short collated nail 50b. This blocking prevents misalignment and subsequent triggering, enabling a more stable and more safe nailer.

The present invention also includes an end wall 41 of nail tank 31 of the nail cartridge 30 being provided with a relief groove 42. When triggering is finished, the collated nail shifts towards the outlet 40 until the nailer head stops at the end wall 41 of outlet. The end 54 of connecting band 53 exceeding the nail head 51b inserts into the relief groove 42, ensuring that the nail head 51b stops at the end wall 41 of the outlet 40 for a correct triggering.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an isolated perspective view of long collated nails being installed into the nail cartridge.

FIG. 2 shows an exploded and isolated perspective view of short collated nails being correctly and incorrectly installed into the nail cartridge.

FIG. 3 shows an isolated perspective view of a spring when no collated nails are installed into the nail cartridge of the present invention.

FIG. 4 shows an exploded and isolated perspective view of the spring stopped by the stopper when the short collated nails are incorrectly installed into the nail cartridge, the short collated nails being misaligned.

FIG. 5 shows a top plan view of the short collated nails and spring of FIG. 4.

FIG. 6 shows an exploded and isolated perspective view of the present invention when short collated nails are aligned and inserted smoothly into the nail cartridge.

FIG. 7 shows a top plan view of the short collated nails and spring of FIG. 6.

FIG. 8 shows an exploded and isolated perspective of the present invention when the long collated nails are inserted into the nail cartridge.

FIG. 9 shows a cross-sectional view of the present invention when a relief groove is set on the end wall of a nail tank in the nail cartridge.

FIG. 10 shows a schematic view of the operation of the relief groove disclosed in FIG. 9, when the nail body of the collated nail is triggered.

FIG. 11 shows another schematic view of the operation of the relief groove disclosed in FIG. 9, when the connecting band of the triggered nail body of the collated nail inserts into the relief groove.

FIGS. 12-14 show isolated perspective views of the blocking by the spring stopper when the reverse nail cartridge enters the nail tank.

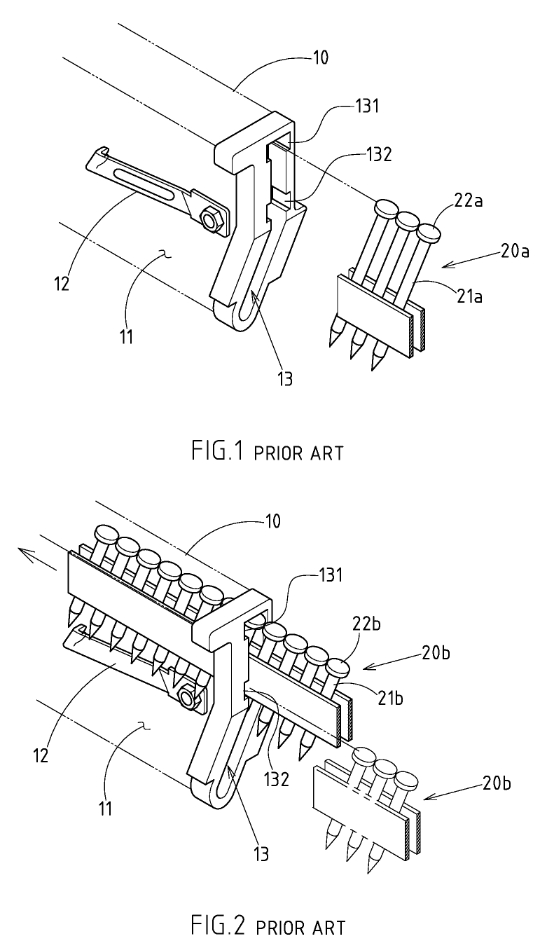

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

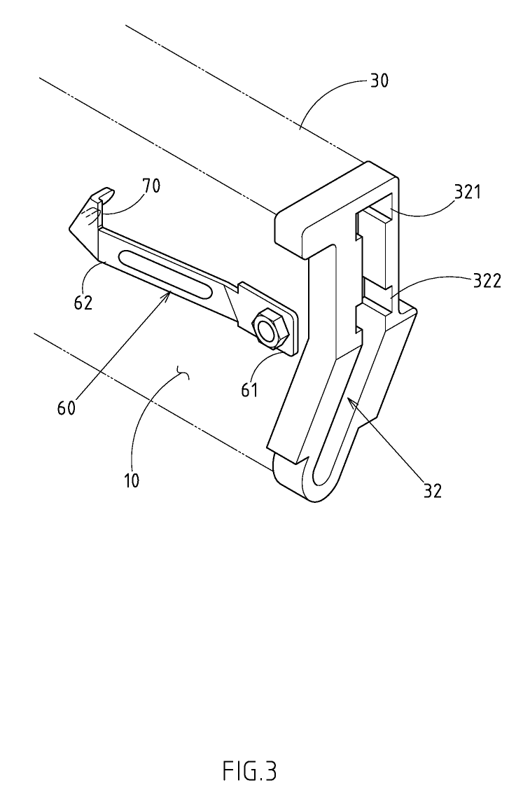

FIGS. 3, 4, and 5 depict preferred embodiments of the anti-misfit structure for a nail cartridge of the present invention. The nail cartridge is a component of a nailer used to accommodate and guide collated nails.

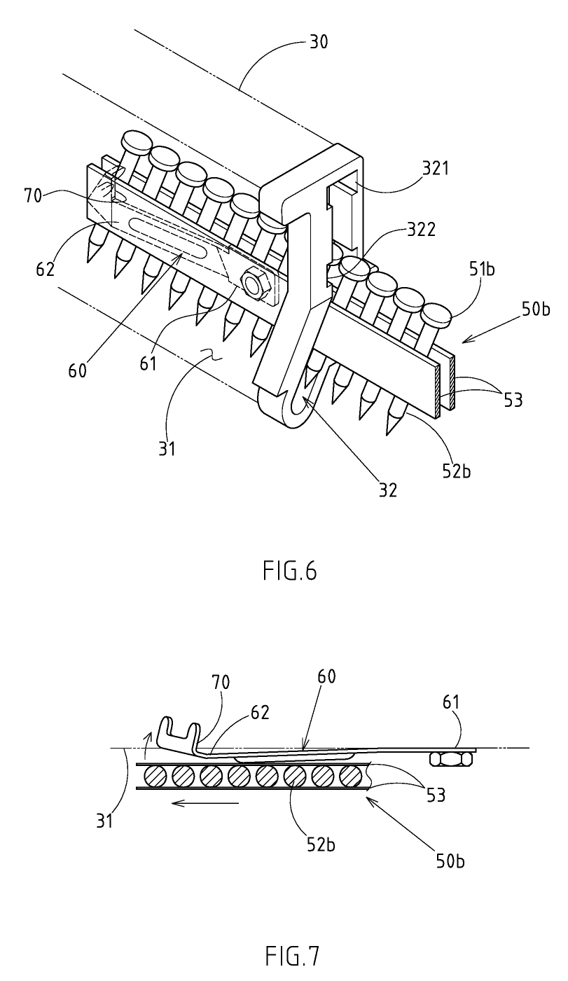

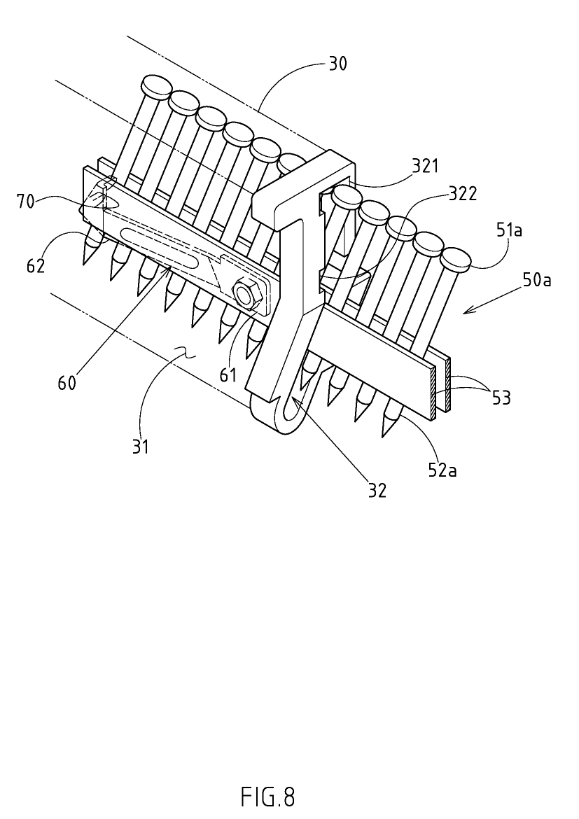

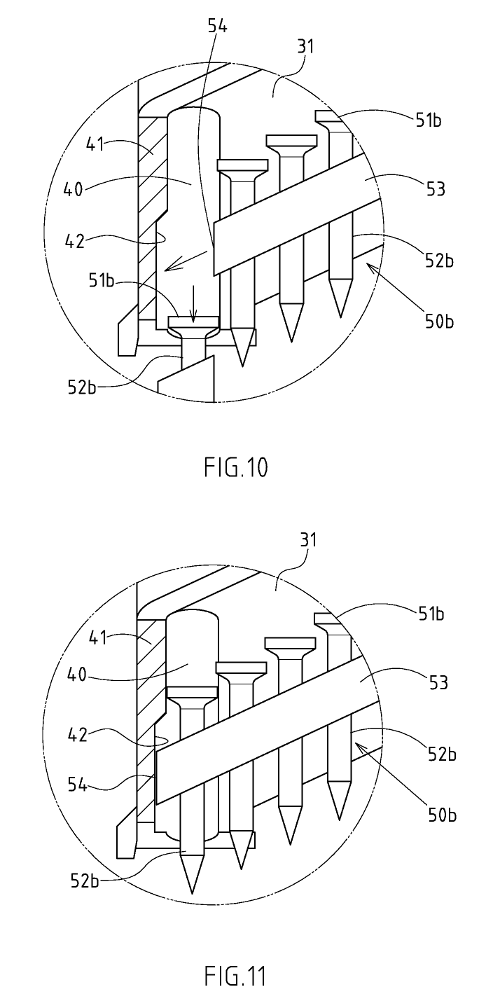

The present invention includes a nail cartridge 30, which has a nail tank 31. One end of the nail tank is connected to outlet 40 of the nailer, as shown in FIG. 10. The other end of nail tank 31 is provided with an inlet 32 for insertion of preset collated nail. A long nailer head dent 321 and a short nailer head dent 322 are separately placed at top and middle sections of the inlet 32. The long nailer head dent 321 is used for insertion of the nail head 51a of a longer collated nail 50a, as shown in FIG. 8. The short nailer head dent 321 is used for the nail head 51b of a shorter collated nail 50b, as shown in FIG. 6. The nail bodies 52a, 52b of the collated nail 50a, 50b are linked by left and right connecting band 53, e.g. paper tape.

A spring 60 is mounted at one side of nail tank 31 of nail cartridge 30 slightly lower than the short nailer head dent 321. The spring 60 includes a fixed end 61 and a swinging end 62. The swinging end 62 normally protrudes towards the nail tank 31, being directed towards a collated nail.

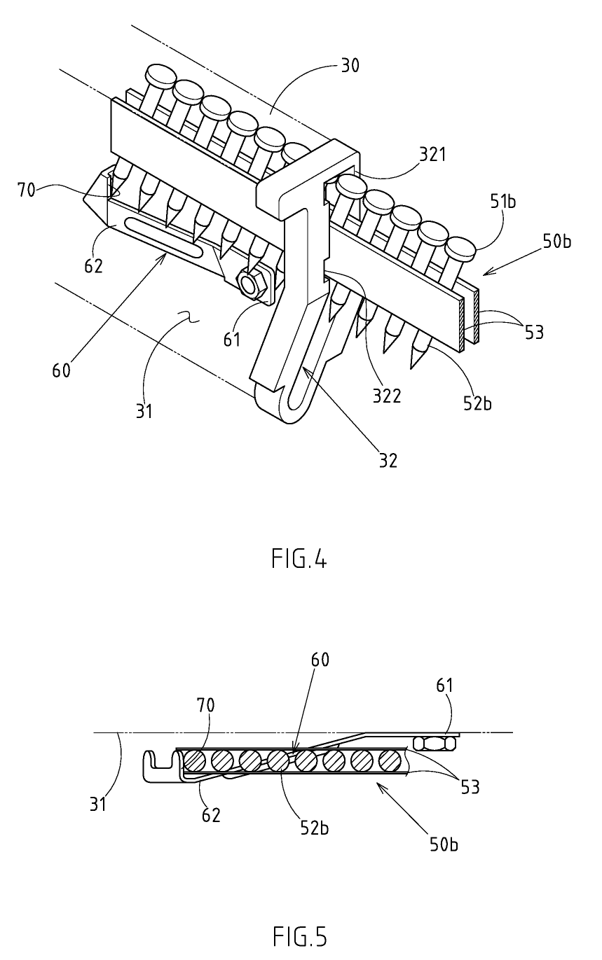

A stopper 70 protrudes from a top end of swinging end 62 of the spring. When the nail head 51b of a shorter collated nail 50b is mistakenly inserted into long nailer head dent 321 (as shown in FIG. 4), the protruding height of stopper 70 is enough to stop the shorter collated nail so as to prevent misalignment of the collated nails during the nail loading process.

The stopper 70 is integrally formed by the swinging end 62 of the spring. For example, the spring 60 of the present invention is formed by the stopper 70 punched through sheet metal.

The stopper 70 may also be fabricated separately and then assembled at the swinging end 62 of the spring 60.

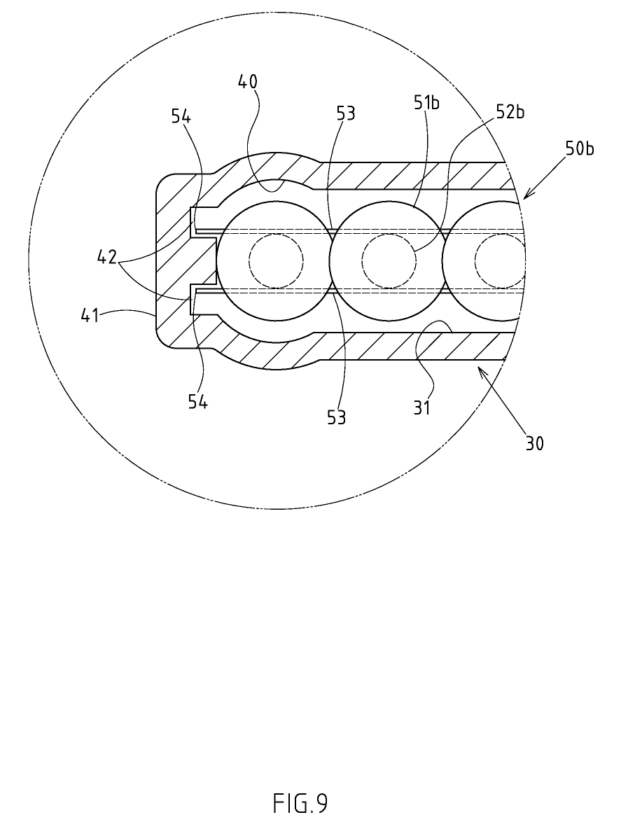

Referring to FIGS. 9 and 10, a relief groove 42 is placed at end wall 41 linking the nail tank 31 of nail cartridge 30 and nailer outlet 40, such that the connecting band 53 of collated nails 50a, 50b can be inserted. The relief groove 42 can be formed by two interval notch grooves, as shown in FIG. 9, at left and right sides of the collated nails. Referring to FIG. 10, when the nail body 52b at a top of the collated nail 50b is triggered to protrude from the outlet 40, a space is formed. Meanwhile, the connecting band 53 of the triggered nail body 52b is forcibly split. Referring also to FIG. 10, after the triggering behavior is started, the collated nail 50b slips towards the outlet 40 to make up the vacancy until nail head 51b of nail body 52b is stopped at end wall 41 of the outlet 40. In such case, if the end 54 of connecting band 53 exceeds the nail head 51b, the collated nails are allowed to be inserted into relief groove 42, ensuring that nail head 51 could be really stopped at the end wall 41 of the outlet 40 for correct positioning and triggering.

Based upon above-specified structure, the present invention operates as detailed herein.

Referring to FIGS. 4 and 5, when the nail head 51b of a short collated nail 50b is mistakenly inserted into the nail tank 31 from long nailer head dent 321, the bottom of nail body 52b of the collated nail is stopped by the stopper 70 at a top of the swinging end 62 of spring 60 within the nail tank 31. In such case, the bottom of collated nail cannot contact other positions of the spring 60 for pressing the swinging end 62. So, the short collated nail 50b cannot be inserted, and this installation error can be found, thus preventing the misalignment phenomenon during nail loading.

Referring to FIGS. 6 and 7, when the nail head 51b of a short collated nail 50b is inserted into nail tank 31 from the short nailer head dent 322, one side of the collated nail passes over the fixed end 61 of spring 60. Then, the swinging end 62 is enabled to be pressed on the side wall of nail tank 31, since the swinging end 62 of the spring 60 extends towards the nail tank 31. In such a case, the stopper 70 fails to block off the short collated nail 50b with the motion of swinging end 62, enabling the short collated nail 50b to be inserted into the nail tank 31 for correct loading.

Referring also to FIG. 8, the nail head 51a of a long collated nail 50a is inserted into the nail tank 31 from long nailer head dent 321. Thus, it is possible to press the swinging end 62 of spring 60 into the nail tank 31 for correct nail loading, the same way as shown in FIGS. 6 and 7.

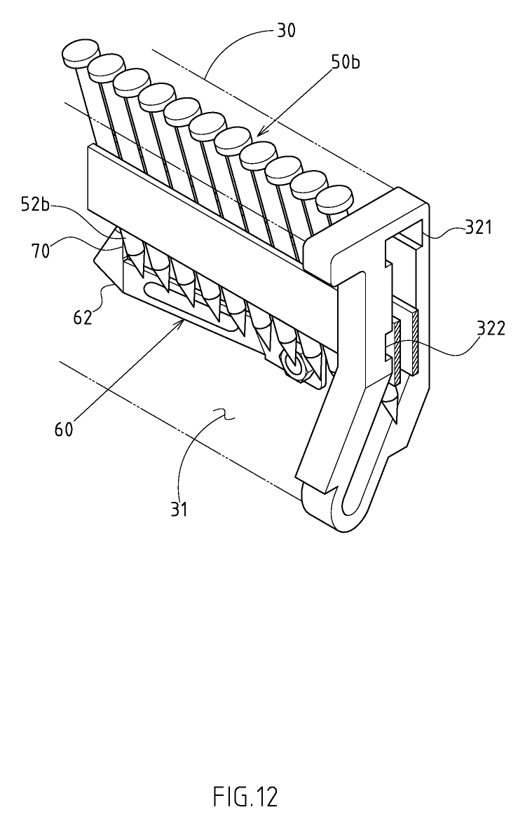

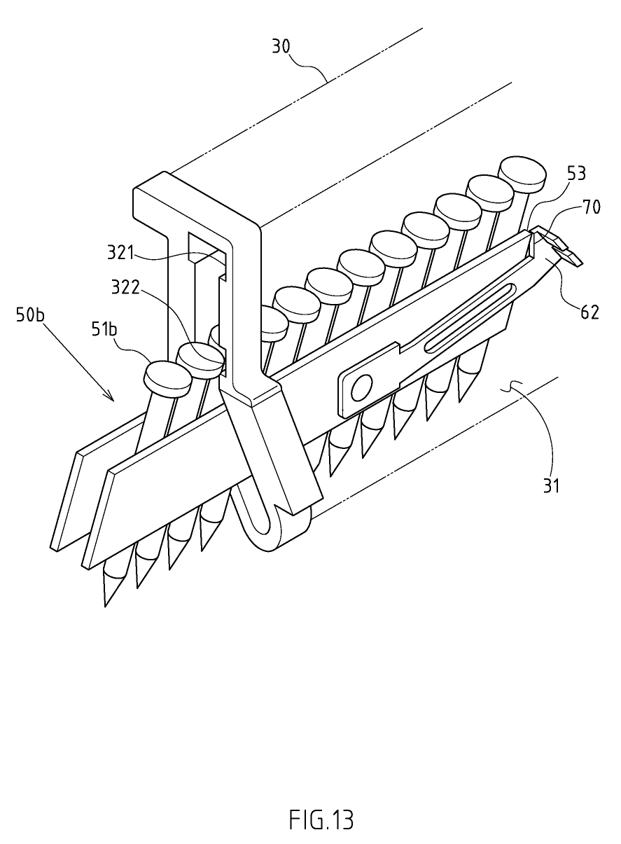

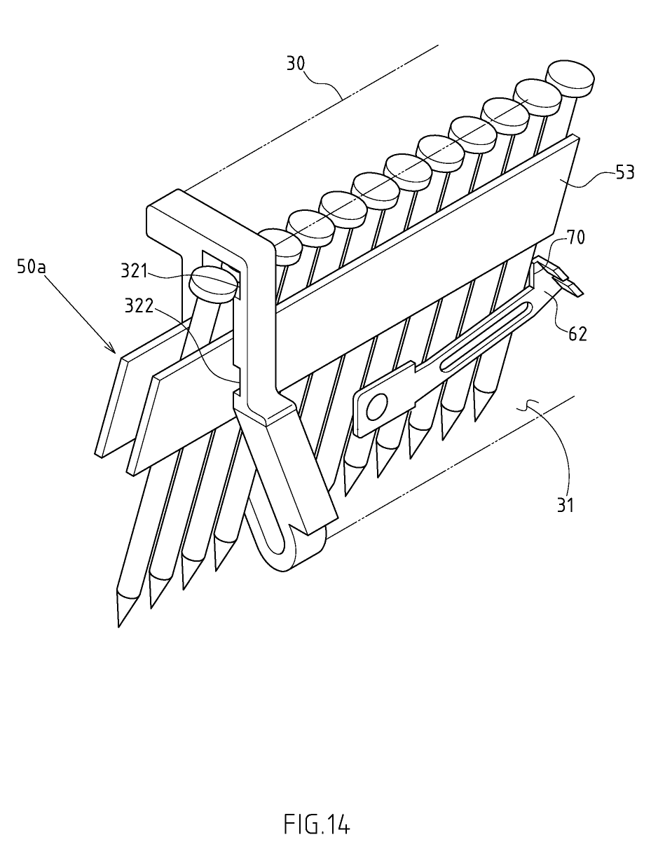

Furthermore, the spring 60 has a protruding stopper 70 on the top of swinging end 62, so as to prevent the nailing process from “displacement”, and use the stopper 70 for blockage when the nail body is reversed (the rear side being switched to the front side) into the nail cartridge. As shown in FIG. 12, when the short collated nail 50b is placed into the nail tank 31 of the nail cartridge 30 in reverse, the bottom of nail body 52b is blocked by the protruding stopper 70 at the top of the swinging end 62 of the spring 60, so that users can identify the mistake and correct the direction. As shown in FIG. 13, when the nail head 51b of the short collated nail 50b is placed in the nail tank 31 from the correct short nail head dent 322 in reverse, since the connecting band 53 of the short collated nail 50b is inclined forward, the top of the swinging end 62 of the spring 60 is blocked to prevent incorrect assembly. As shown in FIG. 14, when the long collated nail 52a is placed in the nailed tank 31 of the nail cartridge 30 in reverse, the nail body is inclined forward, and it is blocked by the protruding stopper 70 on the top of the swinging end 62 of the spring 60, so that the reversed long collated nail 52a is unable to enter the nail tank 31, thus achieving the purpose of preventing incorrect assembly.

We claim:

1. An anti-misfit structure for a nail cartridge, comprising:
a nail cartridge with a nail tank, said nail tank having an inlet for insertion of a collated nail, said inlet having a first nailer head dent placed at a top section of said inlet and a second nailer head dent at a middle section of said inlet, said collated nail having a first nailer head able to be inserted into said first nailer head dent or a second nailer head able to be inserted into said second nailer head dent, said collated nail with a first nailer head being longer than said collated nail with a second nailer head;
a spring, being mounted at a preset height of one side of said nail tank and being comprised of a fixed end and a swinging end, said swinging end protruding outwardly towards said nail tank; and
a stopper, protruding from a top of said swinging end, said stopper blocking said collated nail with said second nailer head when said collated nail with said second nailer head is inserted into said first nailer head dent.

2. The anti-misfit structure defined in claim 1, wherein said stopper is integrally formed by said swinging end of said spring.

3. The anti-misfit structure defined in claim 1, wherein said stopper is formed separately and then assembled to and at said swinging end of said spring.

4. An anti-misfit structure for a nail cartridge, comprising:
a nail cartridge with a nail tank, said nail tank having one end connected to an outlet and another end provided with an inlet for insertion of collated nails, said collated nails having nail bodies linked by a connecting band, said inlet having a first nailer head dent placed at a top section of said inlet and a second nailer head dent at a middle section of said inlet, said collated nails each having a first nailer head able to be inserted into said first nailer head dent or a second nailer head able to be inserted into said second nailer head dent, said collated nails with a first nailer head being longer than said collated nails with a second nailer head;
a spring, being mounted at a preset height of one side of said nail tank and being comprised of a fixed end and a swinging end, said swinging end protruding outwardly towards said nail tank; and
a stopper, protruding from a top of said swinging end, said stopper blocking said collated nail with said second nailer head when said collated nail with said second nailer head is inserted into said first nailer head dent.

5. The anti-misfit structure defined in claim 4, wherein said stopper is integrally formed by said swinging end of the spring.

6. The anti-misfit structure defined in claim 4, wherein said stopper is formed separately and then assembled to and at said swinging end of said spring.

7. The anti-misfit structure defined in claim 4, wherein said nail tank has a relief groove placed at an end wall thereof, linking said nail tank and said outlet, said connecting band of collated nails being inserted into said relief groove.

8. An anti-misfit snap for a nail cartridge, comprising:
a fixed end;
a swinging end, protruding towards one side; and
a stopper, protruding at a preset side of said swinging end.

9. The anti-misfit snap defined in claim 8, wherein said stopper is integrally formed by said swinging end.

10. The anti-misfit snap defined in claim 8, wherein said stopper is formed separately and then assembled to and at said swinging end.
